(19) United States
(12) Patent Application Publication
(10) Pub. No.: US 2014/0222606 A1
(43) Pub. Date: Aug. 7, 2014

(54) VARIABLE QUANTITY AUCTION SYSTEM AND METHOD

(71) Applicant: ZIONS BANCORPORATION, SALT LAKE CITY, UT (US)

(72) Inventors: William David Hemingway, Salt Lake City, UT (US); Evan Martin Hill, Sandy, UT (US)

(73) Assignee: ZIONS BANCORPORATION, SALT LAKE CITY, UT (US)

(21) Appl. No.: 14/170,145

(22) Filed: Jan. 31, 2014

Related U.S. Application Data
(60) Provisional application No. 61/760,069, filed on Feb. 2, 2013.

(51) Int. Cl. G06Q 30/08

(52) U.S. Cl. CPC G06Q 30/08
USPC 705/26.3

(57) ABSTRACT

The present disclosure provides systems and methods for conducting a variable quantity auction. A seller may determine a quantity range of items to be sold and a reserve price for acceptable bids. The auction may proceed in two phases. In a first phase, bidders bid on a quantity of items at a price that is at least the reserve price. In various embodiments, the first phase may be used to determine the total number of items to be sold in a second phase. In the second phase a price for the fixed quantity of items may be determined. In various embodiments, the second phase may proceed as a typical second item auction in which bidders may modify their bids until the end of the auction. The winning bidders may only pay for their items at the lowest qualifying bid.

### CROSS-REFERENCE TO RELATED APPLICATIONS

The present application claims the benefit under 35 U.S.C. §119(e) of U.S. Provisional Patent Application 61/760,069 filed Feb. 2, 2013, titled “Variable Quantity Auction System And Method,” which application is hereby incorporated herein by reference in its entirety.

### TECHNICAL FIELD

This disclosure relates generally to financial securities. More particularly, this disclosure relates to online auctioning of financial securities.

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram illustrating the use of tracking instruments for estimating the expense of granting employee stock options, according to one embodiment;

FIG. 2 is a block diagram illustrating the involvement of a grantor trust to create, issue and auction the tracking instrument of FIG. 1, according to another embodiment;

FIG. 3 is a flow chart of certain embodiments for selling rights to a derivative cash flow corresponding to employee stock options;

FIG. 4 is a flow chart of a method for paying holders of tracking instruments, according to one embodiment;

FIG. 5 is a flow chart of a method for auctioning tracking instruments, according to one embodiment;

FIG. 6 is a flow chart of a method for handling modifications to employee stock options, according to one embodiment;

FIG. 7 is a flow chart of a method for handling pre-vesting forfeitures of employee stock options, according to certain embodiments;

FIG. 8 is another flow chart of a method for handling pre-vesting forfeitures of employee stock options, according to certain embodiments;

FIG. 9 is another flow chart of a method for handling pre-vesting forfeitures of employee stock options, according to certain embodiments;

FIG. 10 is another flow chart of a method for handling pre-vesting forfeitures of employee stock options, according to certain embodiments;

FIG. 11 is another flow chart of various options for registration or exemption from registration for derivative securities; and

FIG. 12 is a block diagram of an example system for auctioning tracking;

FIG. 13 provides a flow chart of an embodiment for conducting a variable quantity auction;

FIG. 14A illustrates a flow chart of one embodiment for a first phase of a variable quantity auction;

FIG. 14B illustrates a flow chart of one embodiment for a second phase of a variable quantity auction;

FIG. 15 illustrates a computer system and modules for implementing a variable quantity auction.

### DETAILED DESCRIPTION

### Overview of Market-Based Approach to Valuing Employee Stock Options

Disclosed herein is an online auction process for derivative securities used to determine a fair market value of an asset or benefit provided to others. The derivative securities may correspond to any type of asset or benefit. However, certain embodiments used as examples herein are directed to derivative securities that track the intrinsic value realized by employees when exercising employee stock options granted to them by their employers.

An artisan will recognize from the disclosure herein that a “derivative security” is used herein in its broadest ordinary sense and includes, for example, a contract that specifies the rights and obligations between an issuer of the derivative security and a holder of the derivative security to deliver or receive future cash flows (or other assets or securities) based on some future event. The future event may include, for example, the exercise of an employee stock option or other type of option. When used to estimate the value of an asset or benefit, the derivative security may be referred to herein as a “tracking instrument.” Further, referring to example embodiments that use a derivative security to estimate the value of employee stock option grants, a derivative security may be referred to herein as an Employee Stock Option Appreciation Rights Security, or “ESOARS.”

With the promulgation of Statement of Financial Accounting Standards No. 123(R) (FAS 123R), the Financial Accounting Standards Board (FASB) requires the expensing of employee stock options (ESOs). However, there are many features of ESOs that make using conventional option-pricing models inappropriate (e.g., a Black-Scholes model). These features include, for example, the typically long-term nature of ESOs, vesting conditions, nontransferability, nonhedgeability, blackout periods, suboptimal exercise by employees, termination of employees and other forfeiture features.

To arrive at a more accurate option-pricing estimate than that provided by models, the online auction process for contractual rights to future payments disclosed herein parallels the intrinsic value realized by employees for stock options received from their employers. The purpose is to enable companies to obtain a fair market value of these ESOARS for the purpose of FAS 123R employee option compensation expense accounting. In one embodiment, the process follows an online public auction format, which is open to all qualified investors, is arms-length, and is completely transparent. The ESOARS sold through the auction process provide cash flows to the investor that are a percentage of intrinsic value realized through the exercising of options held by employees.

A market approach that includes a fair and open auction for contracts returning to investors payments that track intrinsic value realized by grantees enables a company to determine a fair market value for employee stock options. The market impounds the effects of differences between employee options and regular options and arrives at a fair value. This is a more reasonable approach than either using models that do not account for all of the features of the instruments or making ad hoc adjustments to existing models. Supply and demand forces and investors' self-interest drive the price to its true value.

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

Several aspects of the embodiments described are illustrated as software and/or hardware modules or components. As used herein, a software/hardware module or component may include any type of computer instruction or computer executable code located within a memory device. A software module may, for instance, comprise one or more physical or logical blocks of computer instructions, which may be organized as a routine, program, object, component, data structure, etc., that perform one or more tasks or implement particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Tracking Instruments

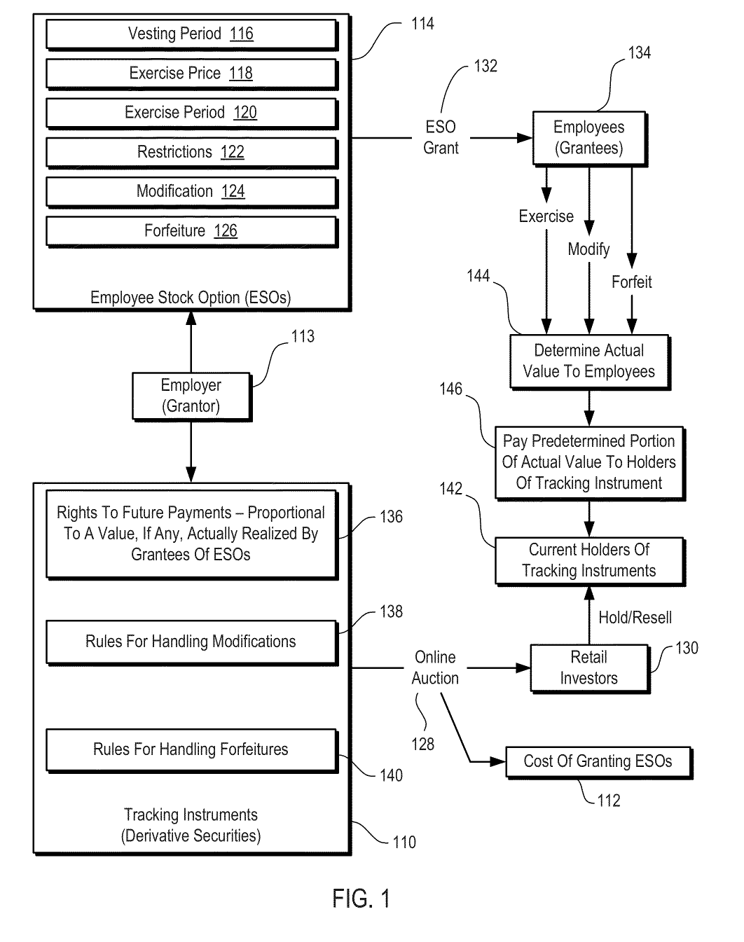

FIG. 1 is a block diagram illustrating the use of tracking instruments 110 for estimating the expense 112 to an employer 113 of granting employee stock options 114 (ESOs 114) according to one embodiment. Generally, the ESOs 114 provide a compensation benefit to employees by allowing the employees, after a vesting period 116, to exercise the ESOs 114 by purchasing stock (securities) in the employer's company at a predetermined exercise price 118 during an exercise period 120. The ESOs 114 are generally subject to many restrictions 122 (e.g., nontransferability, nonhedgeability, and blackout periods), modification 124, and forfeiture 126. As discussed above, conventional option-pricing models are inappropriate for the ESOs 114 due to the generally long vesting periods 116, the restrictions 122, and the other features such as possible modification 124 and forfeiture 126.

Thus, in one embodiment, a market-based approach is used to determine the value of the ESOs 114 for FAS 123R and/or other financial accounting purposes. In the market-based approached disclosed herein, the employer 113 (grantor) provides the tracking instruments 110 via an online auction 128 to retail investors 128. As discussed below, in one embodiment, the tracking instruments 110 are auctioned at substantially the same time (e.g., the same day or before markets open the next day) as the grant 132 of the ESOs 114 to the employees 134, or on another day when valuation of the ESOs 114 is desired or required (e.g., by FAS 123R).

The tracking instruments 110 comprise contractual rights 136 to future payments, rules 138 for handling any modifications 124 to the ESO grant 132, and rules 140 for handling any forfeitures 126 of the ESOs 114 by the employees 134. The rights 136 to future payments are proportional to a value, if any, actually realized by the employees 134 upon exercising their respective ESOs 114. Accordingly, each holder of one or more of the tracking instruments 110 will respectively receive a pro rata share of the net value of the ESOs 114 realized as the employees 134 exercise their respective ESOs 114.

The online auction 128 of any amount of the tracking instruments 110 may result in a valid fair market value of the ESO grant 132. Just as the market value of an enterprise is determinable each day based on a small fraction of the total shares of common stock outstanding exchanged, the tracking instruments 110 may be used to pay investors only a small proportion of the expenses incurred by the company to thereby measure the fair market value of the ESO grant 132. However, in order to attract a meaningful number of qualified bidders, the tracking instruments 110 according to one embodiment pay holders approximately 10% of the actual intrinsic value of the ESOs 114 that are exercised. An artisan will recognize from the disclosure herein that other percentages may also be used. For example, in other embodiments, the tracking instruments 110 pay holders between approximately 5% and approximately 15% of the actual intrinsic value of the ESOs 110 that are exercised. Further, percentages below 5% and above 15% (e.g., 100%) may also be used.

In one embodiment, approximately one tracking instrument 110 is auctioned for each ESO 114 granted to the employees 134. This provides the retail investors 130 with a simple one-to-one correspondence between the tracking instruments 110 and the ESOs 114 and allows smaller investors 130 to bid on relatively small fractions of the value of the overall ESO grant 132. However, in other embodiments, a plurality of ESOs 114 is granted for each tracking instrument 110 provided through the online auction 128. For example, in one embodiment, approximately 100 ESOs 114 are granted for each tracking instrument 110 initially sold to the retail investors 130 because traditional stock options are traded in units of 100. Of course, an artisan will recognize from the disclosure herein that any number of ESOs 114 may be granted for each tracking instrument 110.

In another embodiment, to maintain the notion of one tracking instrument 110 approximately equaling one ESO 114, the ratio of tracking instruments 110 to ESOs 114 is approximately equal to the portion of the actual intrinsic value of the ESOs 114 specified to be paid to the holders of the tracking instruments 110. For example, if the tracking instruments 110 pay holders approximately 10% of the actual intrinsic value of the ESOs 114 that are exercised, then the number of tracking instruments 110 auctioned approximately equals 10% of the number of ESOs 114 provided in the ESO grant 132. In such an embodiment, the valuation of each tracking instrument unit 110 (e.g., the price paid for the tracking instruments 110 through the auction 128) is approximately equal to the expense of each employee stock option in the ESO grant 132 (which may be adjusted for factors such as pre-vesting forfeitures, as discussed below).

The above example illustrates one embodiment for deriving the expense of the ESO grant 132 from a market valuation of the tracking instruments 110. The derived expense is based on a particular ratio of tracking instruments 110 to ESOs 114. An artisan will recognize from the disclosure herein that the expense of the ESO grant 132 may also be derived for other ratios of tracking instruments 110 to ESOs 114. In other words, the estimated expense of the ESO grant 132 depends on the ratio of tracking instruments 110 to ESOs 114 and the rights to future payments 136 provided to holders of the tracking instruments 110. If, for example, there are approximately equal numbers of tracking instruments 110 and ESOs 114, and the tracking instruments 110 are structured to pay 5% of the actual intrinsic value of the ESOs that are exercised, then the total value of the tracking instruments 110 (as determined by the online auction 128) is approximately 5% of the expense of the ESO grant 132. As discussed below, the valuation of the tracking instruments 110 may be adjusted for factors such as pre-vesting forfeitures.

Upon completion of the online auction 128, the winning bidders (discussed below) from among the retail investors 130 are notified. In one embodiment, the tracking instruments 110 are deposited with a Depository Trust Corporation (DTC) and all clearing takes place using well-established mechanisms. In another embodiment, the winning bidders are provided with a certificate indicating ownership of their respective tracking instruments.

There are no restrictions on aftermarket trading or hedging of the tracking instruments. The current holders 142 of the tracking instruments 110 may be the initial retail investors 130 and/or aftermarket investors (not shown). The retail investors 130 who purchased the tracking instruments 110 through the online auction 128 may either hold their respective tracking instruments 110 or may resell all or a portion of their respective tracking instruments 110 to the aftermarket investors.

For example, in one embodiment, the website used to initially auction the tracking instruments 110 may also be used to create a secondary market where current holders of the tracking instruments 110 may auction or otherwise sell their respective interests in the ESO grant 132. Each tracking instrument 110 may be assigned a CUSIP (Committee on Uniform Securities Identification Procedures) number at issue and the employer 113 (or a bank or auction agent) may work with TRACE (Trade Reporting and Compliance Engine) and/or other transaction data providers to record and disseminate post-auction tracking instrument 110 trade data.

As the employees 134 exercise their respective ESOs 114 after the vesting period 116, the actual value 144 realized by the employees 134 is determined. As discussed in detail below, the actual value 144 realized by the employees 134 depends on the number of ESOs 114 that vest, whether the trading price of the employer's underlying securities exceeds the exercise price 118, and the number of ESOs 114 that the employees 134 choose to exercise during the exercise period 120. Further, the actual value 144 may depend on the rules 138 for handling any modifications 124 to the ESO grant 132 and/or the rules 140 for handling any forfeitures 126 of the ESOs 114 by individual employees 134.

Periodically, as the employees 134 exercise the ESOs 114, the current holders 142 of the tracking instruments 110 are paid 146 the predetermined portion of the actual value 144 realized by the employees 134. Again, the predetermined portion is specified by the rights 136 to future payments in the tracking instruments 110. Thus, by way of example, if the rights 136 specify 10% of the actual value 144 realized by the employees 134, then the current holders 142 of the tracking instruments 110 would each receive a pro rata share of 10% of the actual value 144, depending on each of the holders 142 respective share of the tracking instruments 110.

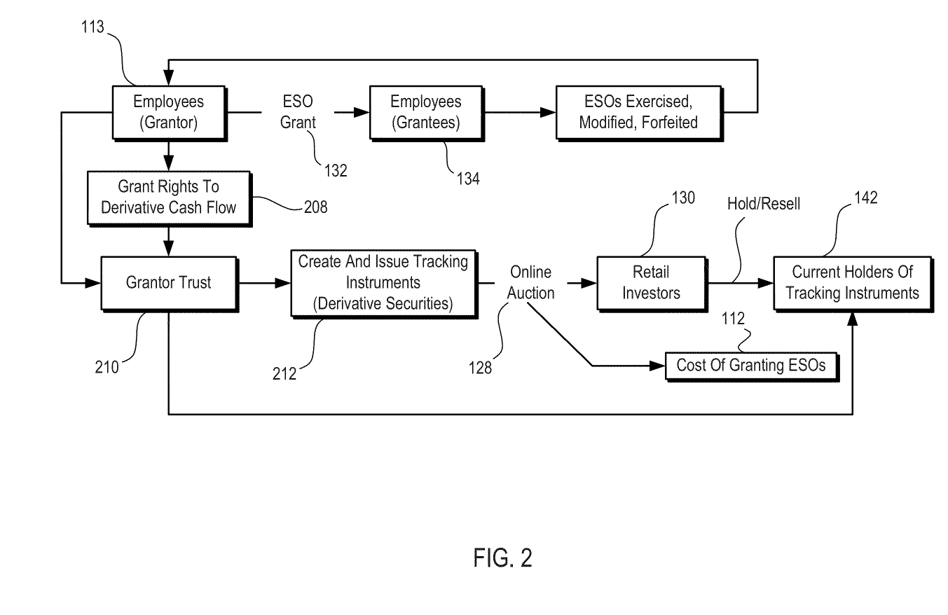

In one embodiment, the employer 113 directly creates, issues, and sells, to the retail investors 130, the tracking instruments 110. However, as shown in FIG. 2, in another embodiment, the employer 113 grants 208 all rights 136 to the future cash flow to a grantor trust 210, which in turn creates and issues 212 the tracking instruments 110 of FIG. 1. The grantor trust 210 performs the online auction 128 to sell the tracking instruments 110 to the retail investors 130. As discussed above, the retail investors 130 may hold or resell their respective tracking instruments 110. The grantor trust 210 auctions 128 the tracking instruments 212 on or near the same day as the ESO grant 132, or at such other time as desired or required to determine the value of the ESO grant 132.

The employer 113 tracks the exercise of the ESOs 114, forfeited ESOs 114, and modifications to the ESO grant 132, and provides this tracking information to the grantor trust 210. The grantor trust 210 uses this information, as discussed herein, to provide pro rata payments to the current holders 142 of the tracking instruments 110 in proportion to the actual value, if any, realized by the employees 134 for the ESOs 114.

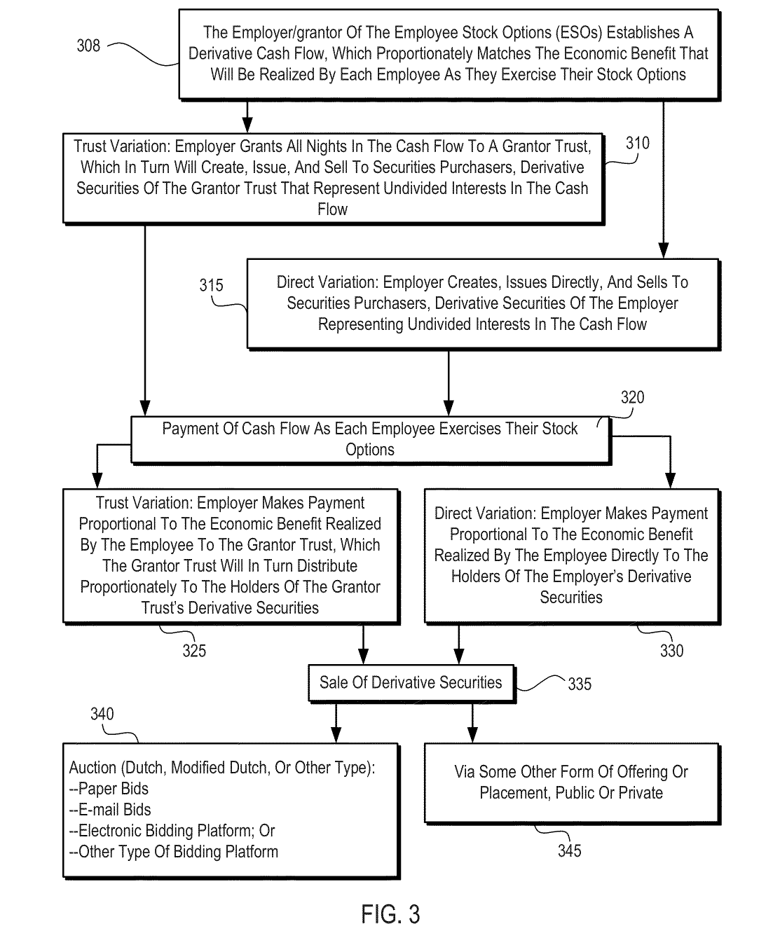

By way of summary, FIG. 3 is a flow chart of certain embodiments for selling rights to a derivative cash flow corresponding to ESOs. Initially, the employer or grantor of the employee stock options establishes 308 a derivative cash flow, which proportionately matches the economic benefit that will be realized by each employee as they exercise their stock options. As discussed above, it is currently anticipated that the proportion will be from approximately 5% to approximately 100%. However, other proportions may be used.

As discussed above, this process may be carried out in two possible variations. First, in the trust variation, the employer grants 310 all rights in the cash flow to a grantor trust, which in turn will create, issue, and sell to securities purchasers derivative securities of the grantor trust that represent undivided interests in the cash flow.

Second, in the direct variation, the employer creates 315, issues, and sells, to securities purchasers, derivative securities of the employer representing undivided interests in the cash flow.

The payment 320 of cash flow as employees exercise their stock options may also vary depending on the variation of the process. In the trust variation, the employer makes 325 a payment proportional to the economic benefit realized by the employee to the grantor trust, which the grantor trust will in turn distribute 325 proportionately to the holders of the grantor trust's derivative securities.

In the direct variation, the employer makes 330 payment proportional to the economic benefit realized by the employee directly to the holder of the employer's derivative securities.

The sale 335 of derivative securities may also vary. In one embodiment, an auction may be held. The auction may be 340 a Dutch auction, a modified Dutch auction, or other type of auction. These may include paper bids, e-mail bids, electronic bidding platforms, or other types of bidding platforms.

In an alternative embodiment, some other form of offering or placement, public or private, may be employed 345.

Determining Payments to Holders of Tracking Instruments

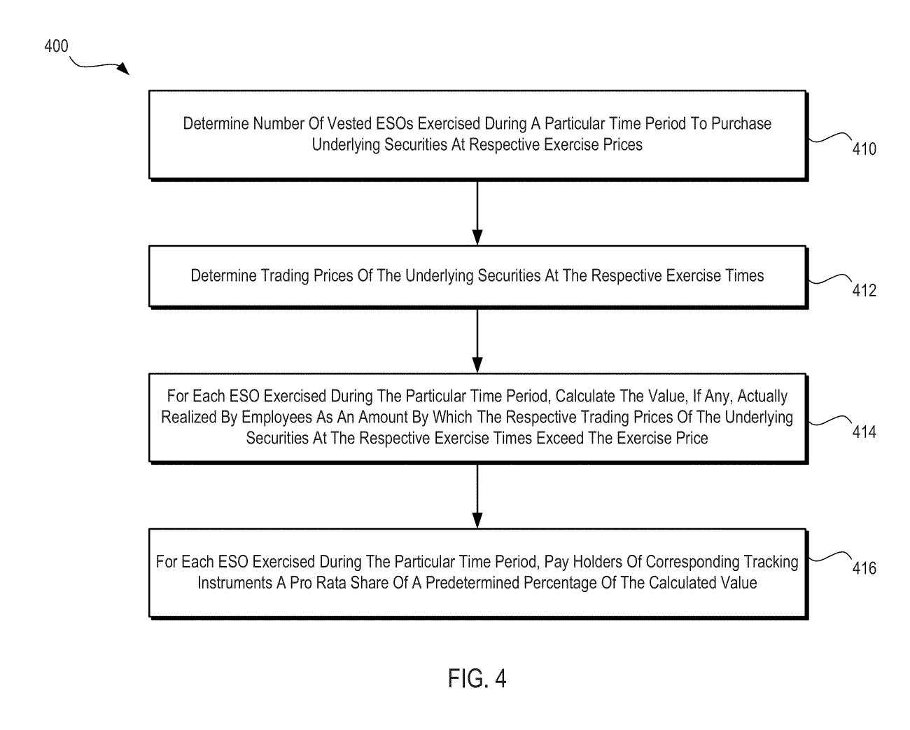

FIG. 4 is a flow chart of a method 400 for paying holders 142 of tracking instruments 110 according to one embodiment. Payments are made, according to certain embodiments, either monthly, quarterly, semi-annually, annually, or on some other predetermined periodic basis. For example, in one embodiment, current holders 142 of tracking instruments 110 are paid quarterly as this frequency strikes a good balance between payment processing costs and liquidity concerns for the holders 142. A quarterly payment schedule is also similar to the payment frequency for equity securities (dividends).

The method 400 includes determining 410 a number of vested ESOs 114 exercised by employees 134 during a particular time period to purchase underlying securities at respective exercise prices 118. The particular time period may be a portion of the exercise period 120. The method 400 also includes determining 412 trading prices of the underlying securities (the employer's stock) at the respective exercise times. The ESOs 114 may be exercised on different days or times during the particular time period. Thus, the method 400 tracks trading prices as each of the ESOs 114 are exercised.

For each of the ESOs 114 exercised during the particular time period, the method 400 calculates 414 the value, if any, actually realized by the employees. The value is equal to an amount by which the respective trading prices of the underlying securities at the respective exercise times exceed the exercise price 118 of the exercised ESOs 114. Then, for each of the ESOs 114 exercised during the particular time period, the method 400 pays 416 the current holders 142 of the tracking instruments 110 a pro rata share of the predetermined percentage of the calculated value specified by the tracking instruments 110. The pro rata share is based on the number of tracking instruments 110 held by each of the current holders 142.

Online Auction

As discussed above, the tracking instruments 110 may be priced and allocated using an online auction process through a website. The auction may be analogous to municipal bond auctions that some banks operate for the public sale of municipal bonds. Details of upcoming auctions for the tracking instruments 110 are distributed in advance to known potential bidders. Public notices may also be given to the financial press. In one embodiment, the information provided to potential investors does not include an expected price range or overall maximum bid price. Suggested bid ranges and/or maximums generally interfere with the fair and open determination of the fair value by unduly influencing or otherwise limiting bidders with respect to pricing.

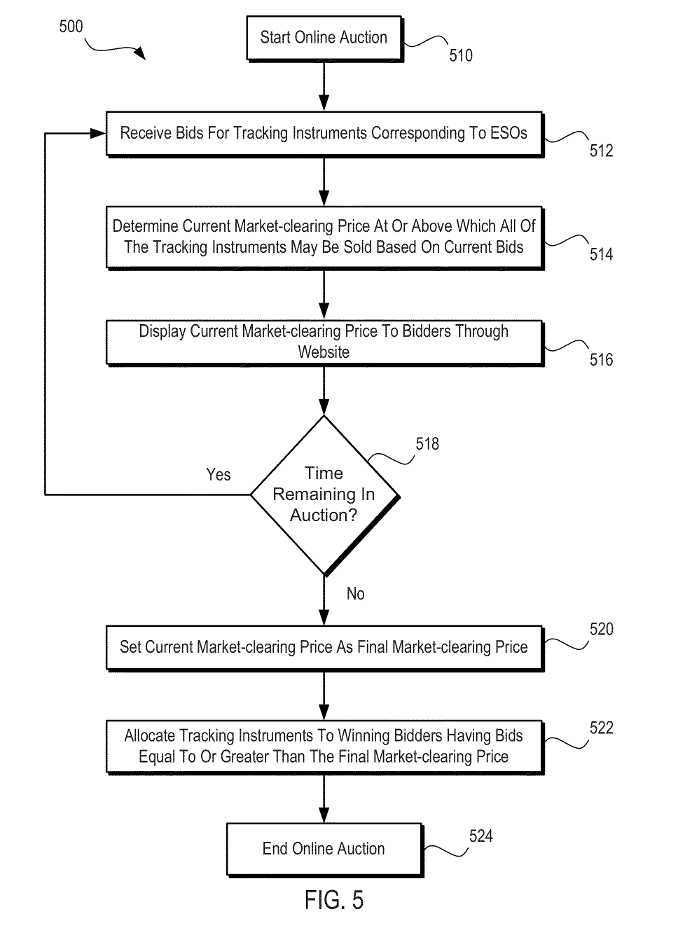

FIG. 5 is a flow chart of a method 500 for auctioning tracking instruments 110 according to one embodiment. After starting 510 the online auction, an application server of an auction website receives 512 bids for tracking instruments 110 corresponding to ESOs 114 of a particular ESO grant 132. In one embodiment, early bids may also be received from bidders before the start 510 of the online auction. Thus, investors who may otherwise be unavailable during the auction period may participate in the auction by submitting early bids. In one embodiment, an early bid form may be downloaded from the auction website and submitted via, for example, the auction website, email, fax or letter.

The tracking instruments 110 are relatively complex and risky securities that do not have direct analogs in the marketplace frequented by most investors. Therefore, in one embodiment, bidders are requested to open an account and/or make a deposit. The bidders may also be prescreened to filter out investors for which the tracking instruments 110 are less likely to be suitable. In one embodiment, potential bidders are provided with a suitability questionnaire, such as a NASD (National Association of Securities Dealers) suitability questionnaire, when applying for a brokerage account. The questionnaire asks potential bidders to identify, for example, their risk tolerance, investment time horizon, and investment objectives. In one embodiment, investors who agree that they have high risk tolerance, a moderate or long investing time horizon and chose speculative trading as one of their investment objectives are allowed to bid for the tracking instruments 110.

In addition to these questions, potential bidders may be probed to determine their understanding of the risks of purchasing the tracking instruments 110. For example, in one embodiment, potential bidders are asked how much they are willing to invest and how much they were willing to lose. The minimum of these two answers is used to set a maximum bid amount. In addition, or in other embodiments, potential bidders may be asked how much they could lose on a $100,000 investment in the tracking instruments 110. If the investor does not answer $100,000, they are contacted to determine whether they understand the nature of the risks of investing in the tracking instruments 110.

In one embodiment, the server identifies bidders only by a bidder number that changes with each auction and is not tied to any personally identifiable information. Thus, the bidders' identities are protected. Once a bid has been submitted, it cannot be lowered or retracted.

In one embodiment, each bidder may place up to five (or another predetermined number) separate, concurrent bids that are each independent of the other. Each of the bids corresponding to a particular bidder may be made for a different numbers of tracking instruments 110 and for different bid prices. In one such embodiment, a bidder will not be able to place an individual bid that exceeds that bidder's maximum bid amount. Thus, a bidder who has one active bid will be able to bid up to her/his maximum bid amount in that one bid. However, a bidder who has, for example, three active bids will be able to bid up to her/his maximum bid amount for each individual bid. However, the bid of a bidder who has placed multiple bids may be deemed to be “in the money” (as discussed below) only to the extent that the aggregate value of the multiple bids is less than or equal to that bidder's maximum bid amount. In short, while a bidder may place multiple bids, each up to her/his maximum bid amount, the most tracking instruments 110 that an “in the money” bidder may be allocated will be that number that his maximum bid amount will purchase.

After receiving bids for at least as many tracking instruments 110 as are being offered, the server determines 514 a current market-clearing price, defined as the highest price at or above which all of the tracking instruments 110 for the ESO grant 132 may be sold based on current bids. To determine the current market-clearing price, the server moves down a list of bids in descending order of price until the total quantity of tracking instruments 110 bid for is at least as large as the number of tracking instruments 110 being sold. For example, assume that 100,000 tracking instruments 110 are being offered and bids have been received from bidders A, B and C according to the table below:

| | No. of Tracking | Bid Price/ |
|---|---|---|
| Bidder | Instruments Requested in Bid | Tracking Instrument |
| A | 50,000 | $100.00 |
| B | 50,000 | $75.00 |
| C | 50,000 | $50.00 |

In this example, $100.00 is not the market-clearing price because only 50,000 of the 100,000 tracking instruments 110 offered can be sold for at least $100.00. Further, $50.00 is not the market-clearing price because, although all of the 100,000 tracking instruments 110 could be sold for $50.00 or more, $50.00 is not the highest price at which all of the tracking instruments 110 can be sold. Instead, the highest price at which all of the offered tracking units 110 may be sold in this example is $75.00. Thus, the current market-clearing price is set at $75.00 and, were the auction to end at this point, 50,000 tracking instruments would be sold to bidder A for $75.00 each and 50,000 tracking instruments would be sold to bidder B for $75.00 each.

In one embodiment, the server displays 516 the current market-clearing price to the bidders through the website. Thus, at any point in time during the auction, the bidders can observe the price at which the market would clear at that point in time. The current market-clearing price may be displayed on a bid page of the website and users may need to refresh the page, or the page may be refreshed automatically, to view the most current market-clearing price. The displayed current market-clearing price provides an indication of the auction's progress. However, as discussed herein, the displayed current market-clearing price may be different than a final market-clearing price at which all of the offered tracking instruments 110 are sold.

Unlike sealed-bid auctions used, for example, by the U.S. Treasury, the method 500 provides an open auction that provides feedback to the bidders and allows them to raise their bids during the course of the auction. In one embodiment, the feedback provides an indication to a bidder as to whether or not the bidder's current bid is “in the money.” If the current bid is in the money, the bid would be a winning bid if the auction were to end at that time. Thus, the online auction provides an active, dynamic market that ensures that at a fair market value is attained.

The server then queries 518 whether there is time remaining in the auction period. In one embodiment, the auction period is in a range between approximately thirty minutes to approximately 5 days. In another embodiment, the auction period is approximately 30 hours. In another embodiment, the auction period is set to be the time between the close of a securities trading market (such as the New York Stock Exchange) on one day and the open of the market on the next day. However, an artisan will recognize from the disclosure herein that many different auction periods may be used and may be based on such factors as investor attention span and investor availability.

If there is time remaining in the auction period, the server continues to receive 512 bids through the website, determine 514 the current market-clearing price based on current bids, and display 516 the current market-clearing price through the website. After the auction period ends, the server sets 520 the current market-clearing price as the final market-clearing price at which all of the offered tracking instruments 110 are sold. The server then allocates 522 the tracking instruments to the winning bidders and ends 524 the online auction. As illustrated in the example above, the bidders A and B would each receive 50,000 tracking instruments 110 at a price of $75.00 each.

In one embodiment, bids above the final market-clearing price are allocated their entire respective quantities of requested tracking instruments 110. If only one bid is at the final market-clearing price, the bidder is awarded all of the remaining tracking instruments 110. If multiple bids are at the final market-clearing price, the server allocates the remaining tracking instruments 110 to the tied bidders on a pro rata basis according to the quantity bid. For example, assume again that 100,000 tracking instruments 110 are offered, and that the following bidders (D, E and F) have bid as follows:

| | No. of Tracking | Bid Price/ |
|---|---|---|
| Bidder | Instruments Requested in Bid | Tracking Instrument |
| D | 50,000 | $100.00 |
| E | 50,000 | $75.00 |
| F | 50,000 | $75.00 |

In this example, $75.00 is the market-clearing price because it is the highest price at which all of the tracking instruments 110 may be sold. Therefore, the servers allocates 50,000 tracking instruments 110 to bidder D for $75.00 each. This leaves 50,000 tracking instruments to be allocated to bidders E and F. Because bother bidders E and F requested 50,000 tracking instruments 110, they will each be awarded 25,000 tracking instruments 110 for $75.00 each.

If on the other hand, bidder E had requested 60,000 tracking instruments 110 and bidder F had requested 30,000 tracking instruments, then bidder E would have received twice (approximately 33.333) as many of the remaining tracking instruments 110 as bidder F (approximately 16.667). In one embodiment, fractional tracking instruments are rounded up to the next whole unit. Thus, in this example, bidder E would receive 34 tracking instruments 110 for $75.00 each and bidder F would receive 17 tracking instruments 110 for $75.00 each. While this rounding up slightly increases the number of tracking instruments 110 sold, the tracking instrument 110 is designed so that the payment received for each unit is substantially unaffected.

Handling Modifications to an Original ESO Grant

A modification to an ESO grant 132 can occur under a variety of circumstances including, for example, repricing or repurchase of awards, adjustment of the term of the vesting period 116, adding reload features, and allowing transferability. Applicable accounting rules may require that the modification be treated as an exchange of the original award for a new award of equal or greater value. In order to determine the expense of a modification, the old and the new ESOs 114 are valued at the time of the modification. The disclosed process for creating and auctioning tracking instruments 110 can easily measure the value of the new ESOs 114 using a new auction of new tracking instruments 110.

However, the valuation of the original ESOs 114 that are being cancelled cannot be accomplished through the disclosed auction process because there will not be any remaining intrinsic value to be realized. FAS 123R states that in the absence of a market price, a model should be used. Further, paragraph A23 states that “[t]he valuation technique . . . should be used consistently and should not be changed unless a different valuation technique is expected to produce a better result.” Since a market value is unattainable, an appropriately designed model may produce a better result. Since the holders of the original tracking instruments 110 receive a payment equal to their share of the cancellation value of the original ESOs 114, the determination of the value of the original ESO grant 132 may be made by an independent agent designated in the initial offering of the tracking instruments 110.

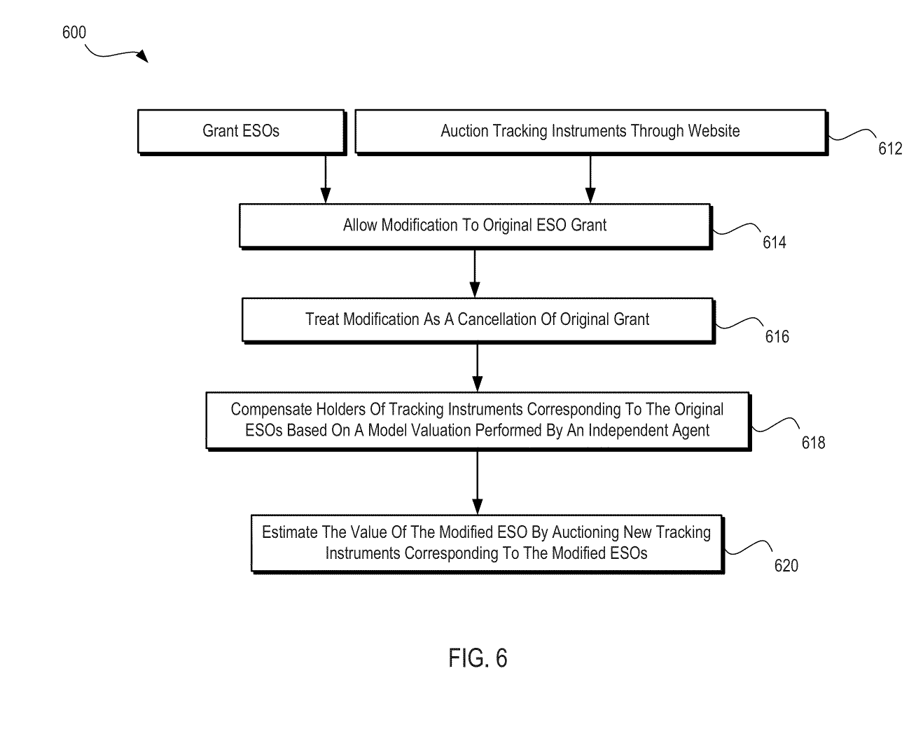

FIG. 6 is a flow chart of a method 600 for handling modifications to ESOs 114 according to one embodiment. The method 600 includes granting 610 the ESOs 114 and auctioning 612 the tracking instruments 110, as discussed above. The method 600 allows 614 modification to the original ESO grant and treats 616 the modification as a cancellation of the original grant.

In one embodiment, the method 600 compensates 618 the current holders 142 of the original tracking instruments 110 with a pro rata share of the cancellation value of the original grant. The original auction 128 received bids on the rights 136 to cash flows that mirror the intrinsic value realized by the employees 134 from exercise of their respective ESOs 114. When the original ESOs 114 are replaced, the original expected cash flows are eliminated. FAS 123R argues that the issuing company is repurchasing the original instrument. Thus, according to this embodiment, the issuing company repurchases the cash flows that would have accrued to the current holders 142 of the original tracking instruments 110 based on a model valuation performed by an independent agent.

The method 600 then estimates 620 the value of the new or modified ESOs 114 by auctioning new tracking instruments 110 corresponding to the modified ESOs 114, as discussed in detail herein.

Handling Pre-Vesting Forfeitures

Under FAS 123R, the final total expense recognized for the ESO grant 132 over the vesting period 116 is the grant-date value per ESO 114 multiplied by the number of ESOs 114 that actually vest. For accounting purposes, the total expense is trued up over the vesting period to reflect only options that vest. In order to align payments for the tracking instruments 110 with the total expense, the ESOs 114 that are forfeited before they vest are not included in the total expense.

Investors 130 in the tracking instruments 110 purchase the right 136 to payments that are based on the entire ESO grant 132, including any ESOs 114 granted that do not vest. Thus, in one embodiment disclosed below, an expected pre-vesting forfeiture rate is disclosed to potential bidders for consideration in the bidding process and then the implied ESO grant valuation is backed out of the market value of the ESO grant derived from the auction of the tracking instrument 110. The number of tracking instruments 110 offered may be based on the expected pre-vesting forfeiture rate. In other embodiments disclosed below, the tracking instruments 110 are designed to remove pre-vesting forfeiture from consideration by the potential bidders.

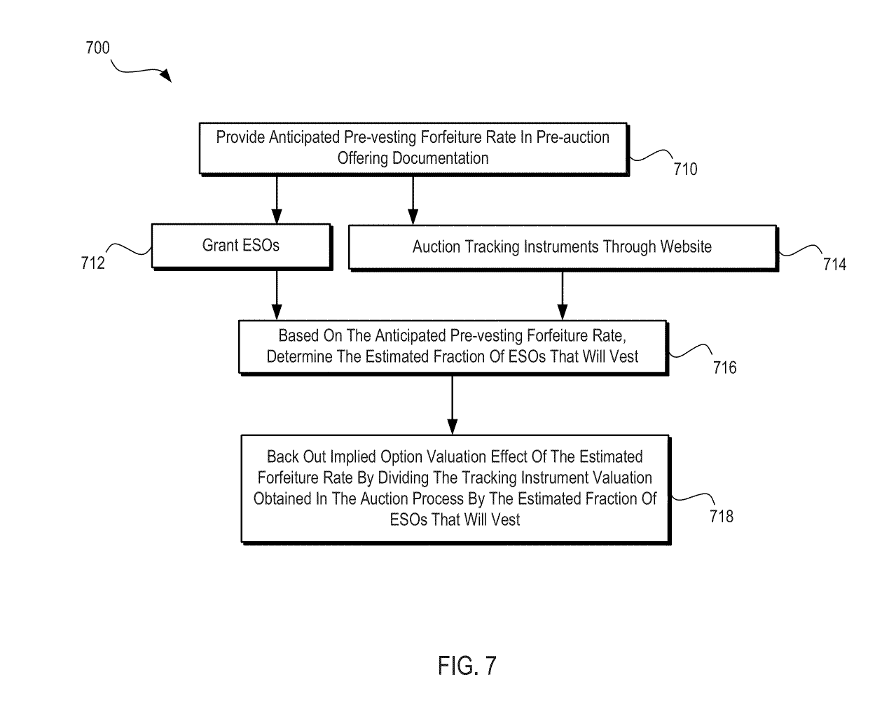

FIG. 7 is a flow chart of a method 700 for handling pre-vesting forfeitures of ESOs 114 according to one embodiment. The method 700 provides 710 an anticipated pre-vesting forfeiture rate to potential bidders in pre-auction offering documentation. The disclosure of this estimated rate allows the potential bidders to incorporate the anticipated pre-vesting forfeiture rate into their bid prices. Based on the anticipated pre-vesting forfeiture rate, the method 700 determines 716 the estimated fraction of ESOs 114 that will be forfeited before vesting.

The method 700 then backs out 718 the implied valuation effect of the estimated forfeiture rate on each of the tracking instruments 110 and accordingly adjusts the final total expense recognized for the ESO grant 132. This is done by dividing the tracking instrument valuation obtained in the auction process by the estimated fraction of ESOs 114 that will vest. The tracking instrument valuation is then converted into a valuation of the underlying ESO 114, which can then be used to measure accounting expense.

For example, assume that the tracking instruments 110 are auctioned for $7.50 each. Also assume that the bidders were given an estimated ESO forfeiture rate of 12.5%, which implies that 87.5% of the ESOs 114 are expected to vest. Dividing the auction-determined price of the tracking instruments ($7.50) by the estimated fraction of ESOs 114 expected to vest (0.875) gives a tracking instrument valuation adjusted for pre-vesting forfeitures of approximately $8.57.

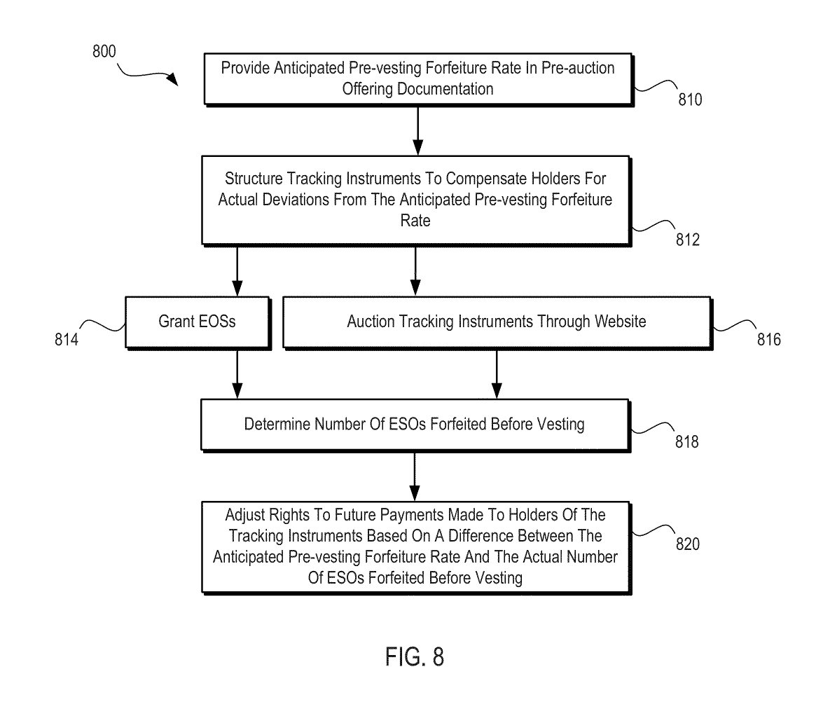

FIG. 8 is a flow chart of a method 800 for handling pre-vesting forfeitures of ESOs 114 according to another embodiment. The method 800 provides 810 an anticipated pre-vesting forfeiture rate to potential bidders in pre-auction offering documentation. However, the method 800 also structures 812 the tracking instruments 110 to compensate the respective holders for actual deviations from the anticipated pre-vesting forfeiture rate. Thus, potential bidders do not need to consider payment for ESOs 114 that do not vest. The final total valuation of the tracking instruments 110 is the market-clearing price per tracking instrument 110 times the number of tracking instruments 110 auctioned. The final total valuation of the tracking instruments 110 is then used to derive the final total expense recognized for the ESO grant 132, as discussed above.

After granting 814 the ESOs 114 and auctioning 816 the tracking instruments 110 through the website, as discussed above, the method 800 determines 818 the number of ESOs 114 that are forfeited before vesting. The method 800 then adjusts 820 the rights 136 to future payments made to holders of the tracking instruments based on the difference between the anticipated pre-vesting forfeiture rate and the actual number of ESOs 114 forfeited before vesting.

For example, assume that the anticipated pre-vesting forfeiture rate is 10% and the actual pre-vesting forfeiture rate is 15%. Payments to the current holders 142 of the tracking instruments 110 is 90/85 of the expected payments, which provides approximately $1.06 for every dollar initially expected to be paid (based on the anticipated pre-vesting forfeiture rate) to the current holders 142 of the tracking instruments 110.

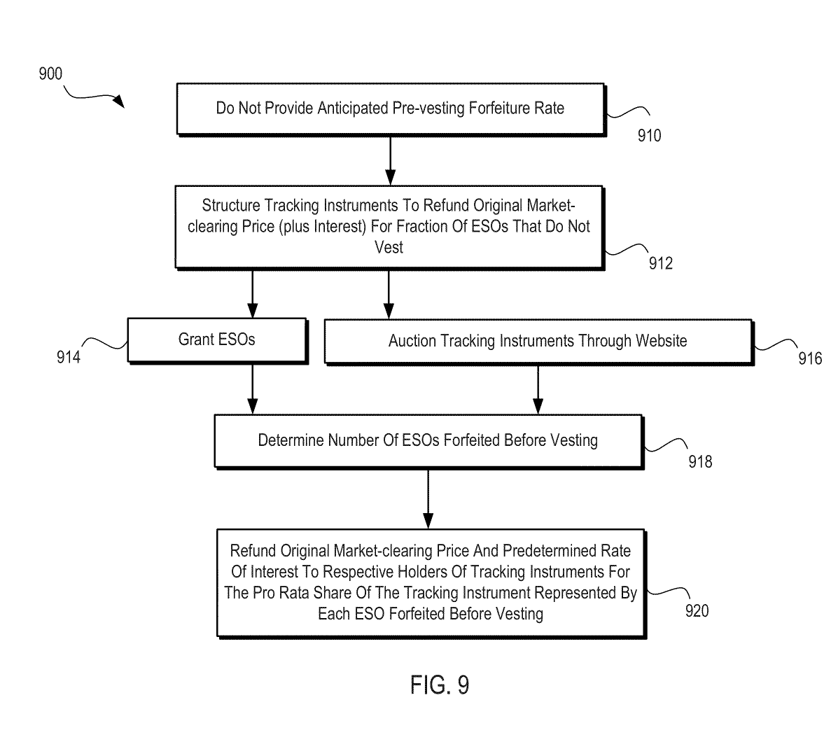

FIG. 9 is a flow chart of a method 900 for handling pre-vesting forfeitures of ESOs 114 according to another embodiment. In this embodiment, the anticipated pre-vesting forfeiture rate is not provided 910 to the potential bidders and the tracking instruments 110 are structured 912 to refund the original market-clearing price of the tracking instrument (plus interest) for the fraction of ESOs 114 that do not vest. Thus, the bidders are made whole for the fraction of ESOs that do not vest and therefore do not need to take pre-vesting forfeitures into account when submitting bids.

After granting 914 the ESOs 114 and auctioning 916 the tracking instruments 110 through the website, as discussed above, the method 900 determines 918 the number of ESOs 114 that are forfeited before vesting. The method 900 then refunds 920 the market-clearing price at which the tracking instruments were sold and a predetermined rate of interest to respective holders 142 of the tracking instruments 110 for the pro rata share of the tracking instrument represented by each ESO 114 forfeited before vesting. In one embodiment, the refund payments are made periodically (e.g., quarterly) during the vesting period 116 as the ESOs 114 are forfeited. Thus, the pre-vesting forfeitures are removed from the bidders' consideration so that they only bid on and receive distributions for units that actually vest.

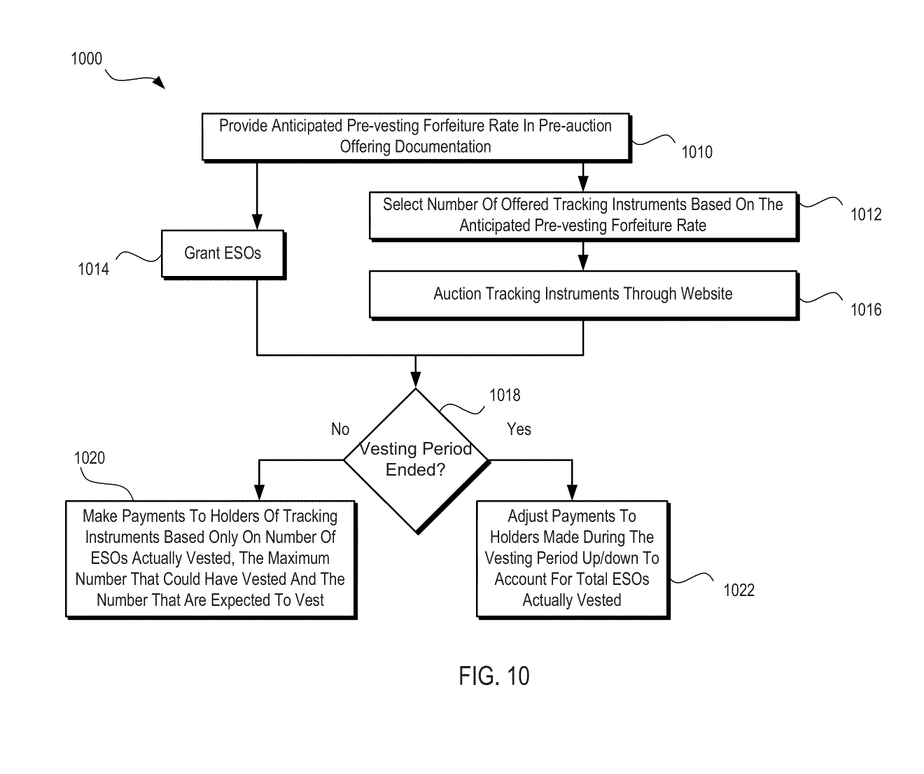

FIG. 10 is a flow chart of a method 1000 for handling pre-vesting forfeitures of ESOs 114 according to another embodiment. Among other things, the method 1000 overcomes a problem of paying the current holders 142 too much during the vesting period 116. The method 1000 provides 1010 an anticipated pre-vesting forfeiture rate to potential bidders in pre-auction offering documentation and selects 1012 the number of offered tracking instruments 110 based on the anticipated pre-vesting forfeiture rate.

If the estimated number of vesting ESOs 114 (based on the pre-vesting forfeiture rate) differs from the number of ESOs 114 that actually vests, a different number of reference options will be available for exercise than was anticipated by bidders. Therefore, the payments to bidders are adjusted up or down so that the payment they receive will be the same as if the estimated number of ESOs 114 is actually realized. This eliminates or reduces the need for bidders to consider pre-vesting forfeitures in their estimation of the value of the tracking instruments 110.

Total payments made to the current holders 142 of the tracking instruments 110 over the life of the reference ESOs 114 is computed, in one embodiment, as the cumulative net realized value from the exercise of the reference ESOs 114 by the employees 134, multiplied by the pro rata share of the net realized value defined by the tracking instruments 110, multiplied by the percentage of the reference ESOs 114 that are expected to vest, divided by the percentage of the reference ESOs 114 actually vested.

Since the fraction of the reference ESOs 114 that will actually vest is not known and will not be known until the vesting period 116 has passed, payments to the current holders 142 of the tracking instruments 110 will be computed using different formulas during the vesting period 116 and after the vesting period 116. This is done to ensure that payments made during the vesting period 116 do not exceed the payments that should be made based on the above formula.

For example, if a higher percentage of the reference ESOs 114 vested than was anticipated, according to the above formula, payments to the current holders 142 would need to be reduced. However, for example, if no reference ESOs 114 were exercised subsequent to the vesting period 116, there would not be an opportunity to reflect in payments to the current holders 142 the higher-than-anticipated vesting rate. The final payment made to the current holders 142 for the reference ESOs 114 exercised during the vesting period 116 will reflect the actual vesting rate so that the above formula holds for the vesting period 116.

Thus, after granting 1014 the ESOs 114 and auctioning 1016 the tracking instruments 110 through the website, as discussed above, the method 1000 queries 1018 whether the vesting period 116 has ended. If the vesting period 116 has not ended, the method makes 1020 payments to the current holders 142 of the tracking instruments 110 based only on the number of reference ESOs 114 that have actually vested relative to the maximum number of ESOs 114 that could have vested and the number of ESOs that are expected to vest according to the anticipated pre-vesting forfeiture rate.

In other words, the payments to the current holders 142 during the vesting period 116 is computed as the net realized value from the exercise of the reference ESOs 114 by the employees 134 during the vesting period 116, multiplied by the pro rata share of the net realized value defined by the tracking instruments 110, multiplied by the percentage of the reference ESOs 114 that are expected to vest during the vesting period 116, multiplied by the maximum number of reference ESOs 114 that could have vested had there been no forfeitures during the vesting period 116, divided by the actual number of reference ESOs 114 that have vested during the vesting period 116.

Using the above formula during the vesting period 116, there may be a slight difference between what was paid and the total payment formula set forth above, evaluated at the end of the final vesting period. Thus, after the vesting period 116, the method 1000 adjusts 1022 the payments made to the current holders 142 made during the vesting period 116 to account for the total ESOs 114 actually vested. Following the vesting period, payments to the current holders 142 are computed as the net realized value from the exercise of the reference ESOs 114 by the employees 134, multiplied by the pro rata share of the net realized value defined by the tracking instruments 110, multiplied by the percentage of the reference ESOs 114 that are expected to vest, divided by the percentage of the reference ESOs 114 actually vested.

Grant Date

FAS 123R requires the valuation of ESOs 114 on the grant date. This is the date the details of the plan are communicated to and accepted by employees. An issue that might arise is the desirability and/or necessity of publishing to potential bidders the details of the plan in advance of the grant date so that the auction can take place on the grant date. However, if the details of the plan are conveyed to potential bidders, they would likely find their way into the public domain and to the employees 134. The standard also notes that the grant date cannot occur until the plan is approved by the board of directors, if so required. Companies may be encouraged to make this a requirement in certain embodiments. In one embodiment, the auction may be held after the stock market closes on the grant date and before it opens on the following day. This may be done to avoid prematurely publishing to potential bidders the details of the ESO grant plan.

FAS 123R defines the grant date as the date when the employer 113 and the employees 134 have a mutual understanding of the key terms and conditions of the grant. One of the key terms may be the exercise price 118 of the ESOs 114. Paragraph A78 of FAS 123R indicates that the exercise price 118 must be known for the grant to have occurred. Thus, in one embodiment, the grant date and the auction date may be aligned by delaying the setting of the exercise price 118 until the auction date.

Offering Memorandum/Prospectus

In certain embodiments disclosed herein the employer 113 provides an offering memorandum/prospectus to potential investors in the tracking instruments 110. The offering memorandum/prospectus provides potential investors with available information to estimate the value of the tracking instruments being offered. The memorandum may include such details as the number of ESOs 114 being granted, service and performance conditions (as defined by FAS 123R), relevant dates, number and types of employees receiving options, post-vesting cancellations, and other useful investment information, broken down into incentive and non-qualified categories. The memorandum may be posted on the Internet and/or a system such as Bloomberg that is available to qualified investors.

As discussed above, the memorandum may also include the employer's expectation for the number of options that will be exercised as well as historical data supporting that expectation. Estimates for pre-vesting forfeitures may include, for example, information on the number of options that are incentive versus non-qualified.

In one embodiment, a document such as a prospectus supplement may summarize information and graphs showing the exercise pattern of the employees 134 for past option grants. For those bidders wanting to complete a more detailed analysis of exercise patterns, free writing prospectuses or other such documents may be provided with the exercise-by-exercise data that underlies the summarized information. The detailed and summarized information may be made available on the SEC Edgar web site.

In addition to providing information potentially useful to prospective bidders for valuation purposes, the information distribution plan may have the secondary objective of informing a sufficient number of bidders of the opportunity to participate in the tracking instruments auction. In order to ensure competitive pricing, a sufficient number of bidders may or should be brought into the auction process. For a market-clearing price to be used to determine fair market value, the FASB requires that the price be derived from an active market. Thus, in one embodiment, as many bidders as possible are attracted through national and local advertising, press releases, working with reporters from national publications in order to get news articles published, and personal contact with known potential bidders.

Registration of Derivative Securities

In one embodiment, the tracking instruments 110 are issued under Rule 144A under the Securities Act of 1933 and are available to the qualified retail investors 130. Alternatively, the tracking instruments 110 may be registered securities. For example, a company could offer tracking instruments 110 through a fully registered offering, such as under the issuing company's WKSI (Well Known Seasoned Issuer) shelf registration with the SEC. The issuing company could participate in the offering of tracking instruments 110 for third party issuers, but could, alternatively, offer them directly to purchasers itself.

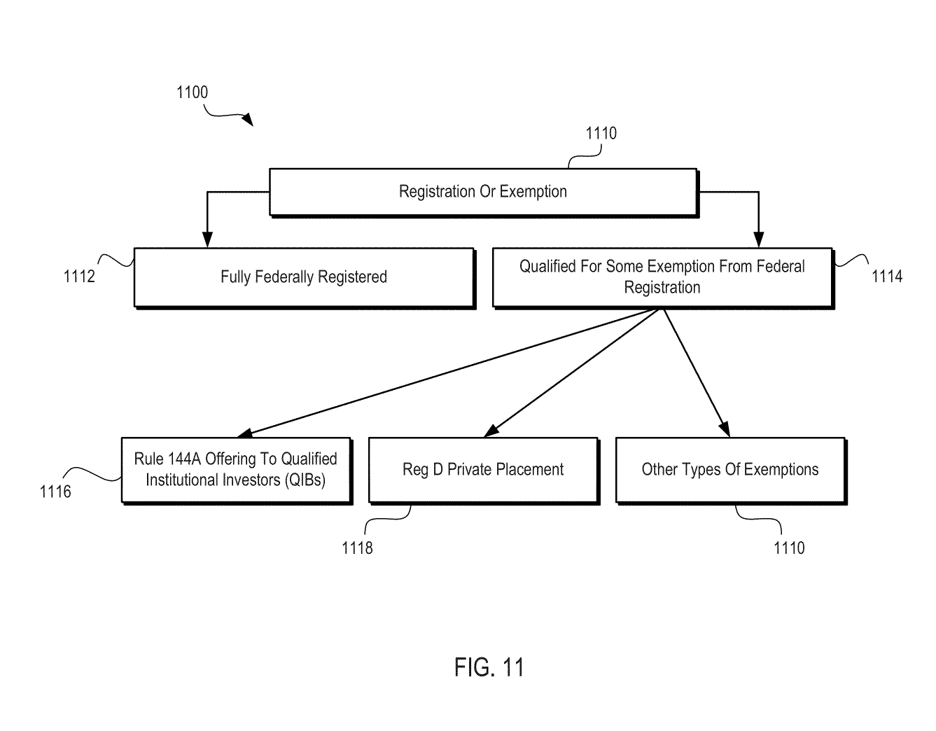

FIG. 11 is a flow chart of various options 1100 for registration or exemption from registration for derivative securities (e.g., the tracking instruments 110). As illustrated, one option 1110 is for the derivative securities to be registered or exempted from registration. For example, the derivative securities may be fully federally registered 1112. Alternatively, the derivative securities may qualify 1114 for some exemption to Federal registration, such as a Rule 144A offering 1116 to Qualified Institutional Buyers (QIBs), a Reg. D private placement 1118, or qualifying 1110 under another type of exemption.

Example Auctioning System

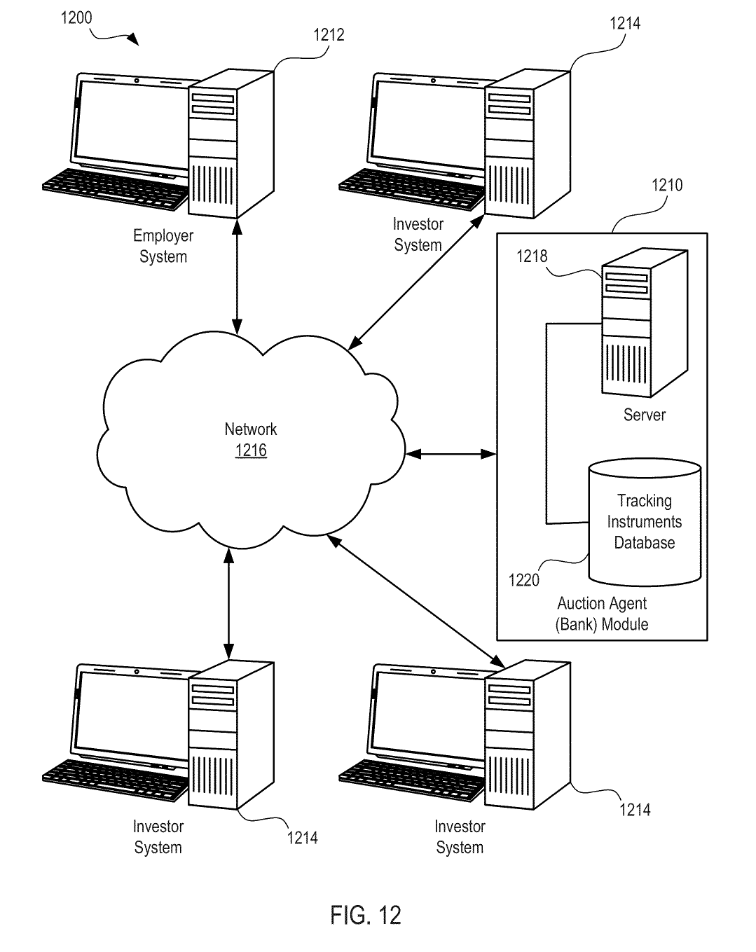

FIG. 12 is a block diagram of an example system 1200 for auctioning tracking instruments 110 corresponding to ESOs 114 according to one embodiment. The example system 1200 includes an auction agent module 1210 in communication with one or more employer systems 1212 (one shown) and a plurality of investor systems 1214 (three shown) through a network 1216. The illustrated components may be implemented using any suitable combination of hardware, software, and/or firmware.

The network 1216 may include, for example, the Internet or World Wide Web, an intranet such as a local area network (LAN) or a wide area network (WAN), a public switched telephone network (PSTN), a cable television network (CATV), or any other network of communicating computerized devices.

The auction agent module 1210 includes a server 1218 and a tracking instruments database 1220. An artisan will recognize from the disclosure herein that the server 1218 and the tracking instruments database 1220 can be implemented on one or more computers. Further, the employer system 1212 and the investor systems 1214 may include computers to communicate through the network 1216. These computers may be single-processor or multiprocessor machines and may include memory having software modules or coded instructions for performing the processes described herein.

The server 1218 is configured to create, issue, and auction tracking instruments 110 to the investor systems 1214 through a website, as disclosed herein. The server 1218 also provides ESO grant 132 valuation and determines payments to the current holders 142 of the tracking instruments 110, as disclosed herein. Thus, the tracking instruments database 1220 includes information used for performing the methods discussed herein. Such information may include, for example, identity and contact information of the current holders 142 and records of the terms provided by the tracking instruments 110. The database 1220 may also include information related to the corresponding ESOs 114 such as pre-vesting forfeiture information, post-vesting forfeiture information, and modification information.

As discussed above, the server 1218 may also facilitate an aftermarket for the tracking instruments 110 that the server 1218 initially auctions to the investor systems 1214. Thus, the server 1218 may provide a website selling or auctioning platform for the investor systems 1214 to sell their respective tracking instruments 110 initially purchased through the online auction from the employer system 1212 or a grantor trust system (not shown), to third party investors. The server 1218 may also provide cross trades between the initial investor systems 1214. For example, a large holder of the tracking instruments 110 may want to divest its holdings by scheduling and running an auction through the website provided by the server 1218.

The auction agent module 1210 may be provided for example, by a third party auctioning agent, the employer system 1212, or a bank. A bank, for example, may take on several roles in creating, issuing, auctioning, and managing the tracking instruments 110, as disclosed herein. For example, a bank may: act as a financial consultant to advise the employer system 1212 on the details of the structure of the contracts and the auction process; hold the auction or act as an auction agent or placement agent for the tracking instruments; provide trust services for the collection and distribution of cash flows, such as in the capacity of trustee, transfer agent, or paying agent; provide the current holders 142 of the tracking instruments 110 and the marketplace a monthly summary of the current vesting, pre-vesting forfeiture, and exercise status of the ESOs 114 associated with their respective tracking instruments 110; act as a riskless principal purchaser or underwriter; act as an information agent; act in some other auxiliary capacity in connection with the issuance, offering, sale, distribution, delivery, registration, payment, and/or transfer of the tracking instruments 110; provide consulting services to assist in the unwinding of modified ESOs 114, as discussed above; and/or assist the employer system 1212 in preparing and circulating an offering memorandum/prospectus regarding the tracking instruments 110.

Variable Quantity Auction

One embodiment of the disclosure includes techniques for conducting a variable quantity auction. For example, a modified “second item” auction may be used for valuing derivative securities, as discussed herein; selling financial securities; and/or selling any type of item that may be sold via an auction. The auction system for conducting the variable quantity auction may be similar or identical to the example auction system discussed above. Similarly, any of a wide variety of known auction methods, systems, and approaches may be utilized in conjunction with the variable quantity auction described herein. A majority of the auctions are described in terms of items for sale in exchange for money. However, it will be appreciated that sellers may auction money and bidders may pay with goods/items, sellers may auction items/goods and bidders may pay with money, and sellers may auction items/goods and bidders may pay with goods/items. Similarly, it is appreciated that any item having value (e.g., points, rewards, options, derivatives, stocks, bonds, goods, financial securities, precious metals, currency, checks, loans, notes, etc.) may be (1) auctioned by the seller and/or (2) used by the bidder to purchased/trade for the auctioned item.

As used herein, in a second item auction, the seller offers a number of identical (or substantially similar) items for sale, so that there may be more than one winning bidder. Each bidder can bid for all the items or only some of them and indicates a price/value that the bidder is willing to pay for each item. Winning bidders may only have to pay the price of the lowest qualifying (successful) bid for the items they won, which is a bid that is equal to or higher than the lowest price at which all of the items would be sold (i.e., the market clearing price).

For example, in some embodiments, a single bidder may bid for some of the items at a first price per item, some of the items at a second price per item, and some of the items at an Nth price per item, where N is an integer greater than 2. In various embodiments, if there are more successful bids than items available, priority goes to the bidders who submitted their bids first.

In some alternative embodiments, if there are more successful bids than items available, the winners may divide the available items based on who submitted their bids first, total number of items requested, historical purchases, and/or any other allocation method, such as pro rata, weighted division, last bidder, etc.

In some instances, a difficulty with second item auctions may be that the number of items is fixed before the auction. A seller may prefer to sell fewer than the total number of available items for a higher price. In some embodiments, a seller may set reserved prices and/or reserve quantities (i.e., minimum subscription sizes). If the reserve price and/or reserve quantity are not reached, the auction is cancelled. This results in a failed auction, frustrating both the seller and the bidders.

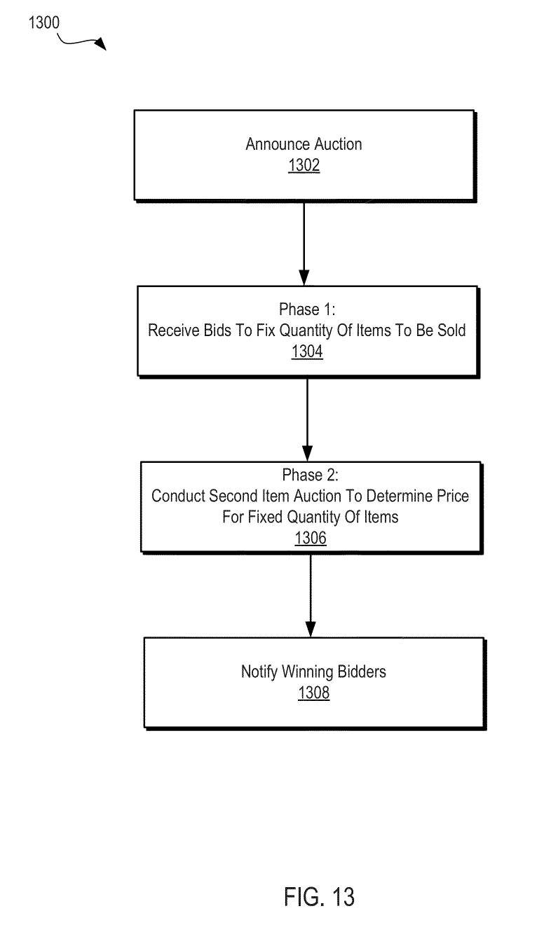

FIG. 13 is a flow chart of one embodiment of a method 1300 for conducting a variable quantity auction. Initially, a seller announces 1302 an offering, which may include a starting and ending time for the auction, a quantity range (or maximum quantity) of items to be sold, and a price range (or reserve/minimum price) for acceptable bids. The quantity range specifies a minimum quantity that the seller is willing to sell and typically a maximum quantity available. In some embodiments, the minimum quantity may be zero and the maximum quantity may be unlimited. However, in many embodiments, the maximum quantity may be based on the total number available and the minimum quantity may be a percentage of the total number of items available and/or a baseline expectation, such as a number of items expected to be necessary to meet a minimum profit, funding, or sales goal.

The reserve price represents a minimum price for which the seller is willing to sell the items in the quantity range. In some embodiments, a suggested maximum price may be provided in order to give guidance to bidders regarding an expected auction result. The suggested maximum price may be used in the context of sales of certain financial securities where regulation deems it necessary. In other embodiments, an enforced maximum price may be provided.

In one embodiment, the auction proceeds in two phases. In a first phase 1304, bidders bid on a quantity of items (up to the maximum) at a price that is at least the reserve price. Bids that are lower than the reserved price are rejected by the auction system. In some embodiments, the reserve price may be dynamically adjusted over time, based on the phase of the variable quantity auction, based on the current number of bids, based on the current bid rate, based on the sum total of items for which bids have been received, and/or other auction factor.

In various embodiments, the first phase 1304 may be used to determine the total number of items to be sold in a second phase 1306, where the total number of items to be sold during the second phase is within the established minimum and maximum number of items to be sold.

In embodiments in which a minimum quantity is established, the auction may fail (e.g., no items are sold and the auction does not proceed to phase 2) if the bidders failed to collectively bid for at least the minimum quantity of items at a price equal to or above the reserve price. That is, where the quantity range includes a minimum quantity, bidders must collectively bid for at least the minimum quantity in order for the auction to proceed. If the minimum quantity is not reached, the auction may be deemed to have failed. Even in a failed auction, valuable information related to the perceived value of the auctioned items may be gained. As described above, the minimum may be low, e.g., one unit, such that the auction may proceed as long as there are any bids.

In one embodiment, the first phase 1304 of bidding may continue until a predetermined time before the announced end of the auction, e.g., t−30 minutes/hours/days/months. At the predetermined time (i.e., the end of phase 1, the total quantity of items bid on during the first phase may be used to determine the fixed quantity of times available during the second phase 1306.

In other embodiments, the first phase 1304 may continue until an arbitrary time determined by an auctioneer. For example, in response to user input to the system by the auctioneer, the first phase may be terminated at any time before the end of the auction. In some embodiments, if a maximum price is set and the maximum number of items are bid for at the maximum price, the auction may end at the end of the first phase with the maximum number of times being sold at the maximum price.

In some embodiments, the auction system may analyze incoming bids to dynamically determine a termination point for the first phase 1304 based on bid quantity, price, and/or other factors. For instance, the auction system may be programmed by the auctioneer with threshold values that, if passed within certain time periods, will terminate the first phase 1304. The conditions under which the first phase will end may be arbitrarily determined by a person or entity. The conditions under which the first phase will end may be publically available and/or kept private from the bidders.

As an example, in an auction in which a maximum of 200,000 units are available, the auctioneer may specify that if bids for 100,000 units are received early in the action, e.g., within the first hour, the first phase 1304 may continue until bids for 150,000 units are received, assuming that this occurs before a fixed time before the end of the auction (e.g., t−45 minutes). On the other hand, if it takes two hours to reach 100,000 units, the system may be programmed to terminate the first phase 1304 as soon as 100,000 units are reached. The system may also be programmed to take into account one or more of a wide variety of factors, including: the number of bidders participating, the frequency of bids received over a period of time, the quantity of the bid(s), the price of the bid(s), the kind of bidder (e.g., retail vs. institutional vs. individual), etc. A skilled artisan will recognize that various combinations of factors may be specified by the auctioneer and stored by the auction system.

As noted above, the first phase 1304 determines the quantity of items to be sold. When the first phase 1304 concludes, the quantity of items is fixed based on the total quantity of items bid for at that point in time. Typically, though not always, the fixed quantity will be greater than the minimum number of items announced prior to the auction (if specified) and less than the maximum number of items available. In various embodiments, the fixed quantity to be sold during the second phase may be equal to the number of items bid on during the first phase, a percentage of the number of items bid on during the first phase (less than or greater than 100 percent), and/or a fixed number above or below the number of items bid on during the first phase.

The method then proceeds with the second phase 1306, in which the auction system determines the price for the fixed quantity of items determined in the first phase 1304. In one embodiment, the second phase 1306 may proceed as a typical second item auction in which bidders may modify their bids until the end of the auction. For example, bidders may increase their bid price, bid quantity, etc. In some embodiments, all bids are effectively reset and the bidders must rebid. In other embodiments, all bids during the first phase remain entered.

In some embodiments, only bidders who bid during the first phase may bid during the second phase. In other embodiments, new bidders may place bids during the second phase. In embodiments in which the auctioned items relate to a coupon, yield, or dividend rate, the bidders may improve their bids by decreasing the rates.

The second phase 1306 continues to the announced ending time of the auction. The winning bidders may only pay for their items at the lowest qualifying (successful) bid, which is a bid that is equal to or higher than the lowest price (or highest yield) for which all of the items are sold.

After the second phase 1306 has determined the price that the winning bidders need to pay, the system notifies 1308 the winning bidders. Notification may be done electronically, e.g., email, SMS, etc., or using other techniques known in the art.

As an example, an auction may be announced offering between 100,000 and 200,000 shares with a reserve price of $10 per share. Three bidders may each bid for a quantity of 50,000 shares, as shown in the table below.

Results of Phase I

| Bidder | Price | Quantity | Quantity Awarded |
|---|---|---|---|
| A | 12.00 | 50,000 | N/A |
| B | 11.00 | 50,000 | N/A |
| C | 10.00 | 50,000 | N/A |

In one embodiment, Phase I continues until 30 minutes before the announced ending time of the auction. At the end of Phase I, the auction size is determined to be 150,000 shares.

In Phase II, bidding moves the price and may reallocate the shares. For example, as shown in the table below, bidder C raised their price to $10.50 per share, and a new bidder D outbid bidder C for 20,000 shares at $10.75 per share. At the end of Phase II, the market clearing price was set at $10.50 per share, and the shares were allocated as shown.

Result of Phase II

| Bidder | Price | Quantity Request | Quantity Awarded |
|---|---|---|---|
| A | 12.00 | 50,000 | 50,000 |
| B | 11.00 | 50,000 | 50,000 |
| C | 10.50 | 50,000 | 30,000 |
| D | 10.75 | 20,000 | 20,000 |

If this had been a non-variable quantity auction, where 200,000 shares had been offered, the result could have either been (1) a failed auction or (2) a sale of 150,000 shares at the reserve price of $10 per share. However, the variable quantity auction described herein (1) allowed the auction to continue with a fixed quantity of shares determined during the first phase and (2) resulted in 150,000 shares being sold at $10.50 per share, netting an additional $75,000 in sales over a non-variable quantity auction.

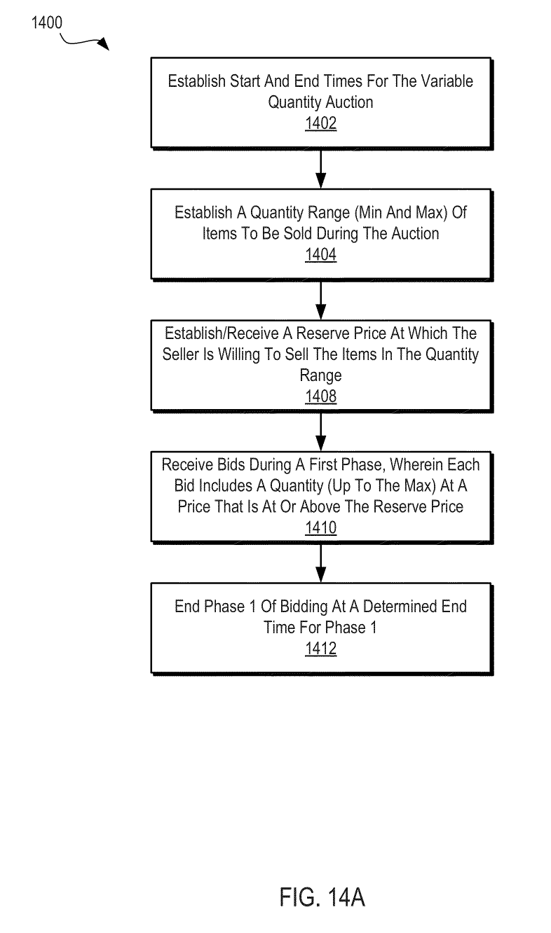

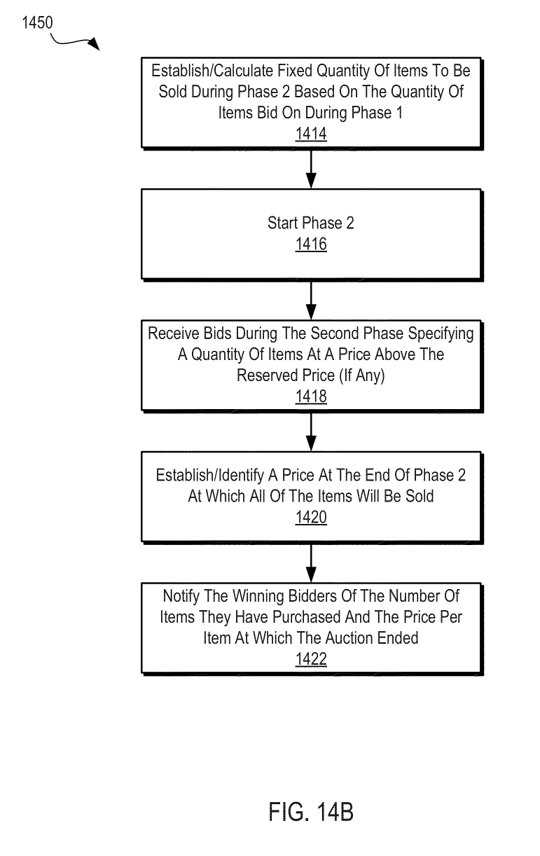

FIG. 14A illustrates a flow chart of one embodiment 1400 for a first phase of a variable quantity auction. As illustrated, a start and end time may be established 1402 for a variable quantity auction. A quantity range may be established 1404 defining a range of the number of items to be sold during the variable quantity auction. The quantity range may include a minimum and/or a maximum number of items to be sold during the variable quantity auction. As described above, the minimum may be zero and the maximum may be unlimited.

A reserve price may be established 1408 at a value greater than zero at which the seller is willing to sell the items within the quantity range. An auctioneer or computerized auction system may receive 1410 bids during the first phase. Bids under the reserve price may be rejected/ignored. Bids may include a quantity and a price per item. The first phase may end 1412 at a predetermined time and/or based on bidding conditions (such as the number of bids received, bid frequency, relative bid frequency, rate of bids being received, quantity for which bids have been received, price at which bids for a certain quantity have been received, etc.).

FIG. 14B illustrates a flow chart of one embodiment 1450 for a second phase of a variable quantity auction. A fixed quantity of items to be sold may be determined based on the quantity of items for which bids were received in the first phase. For example, if bids for 125,000 items were received during the first phase, a fixed quantity of items available for bidding may be equal to or based on 125,000 items. For instance, the fixed quantity of items available for bidding during the second phase may be fixed at 100,000. Alternatively, the fixed quantity of items may be N % higher or lower, such as 90,000 items or 125,000 items. Phase 2 may start 1416 immediately after the conclusion of phase 1 or anytime thereafter. In some embodiments, phase 2 may not begin until a period of time after phase 1 ends.

The auctioneer or the auctioning system may receive 1418 bids during the second phase specifying, again, a quantity of items and a price per item. The bids during the second phase may be received by new bidders and/or the same bidders who bid during phase 1. A price may be established 1420 at the end of phase 2 corresponding to a price at which all or a percentage of the fixed quantity items determined at the end of phase 1 will be sold. The winning bidders 1422 may be notified of their successful bids, funds may be transferred, and/or items may be transferred to satisfy the terms of the bids.

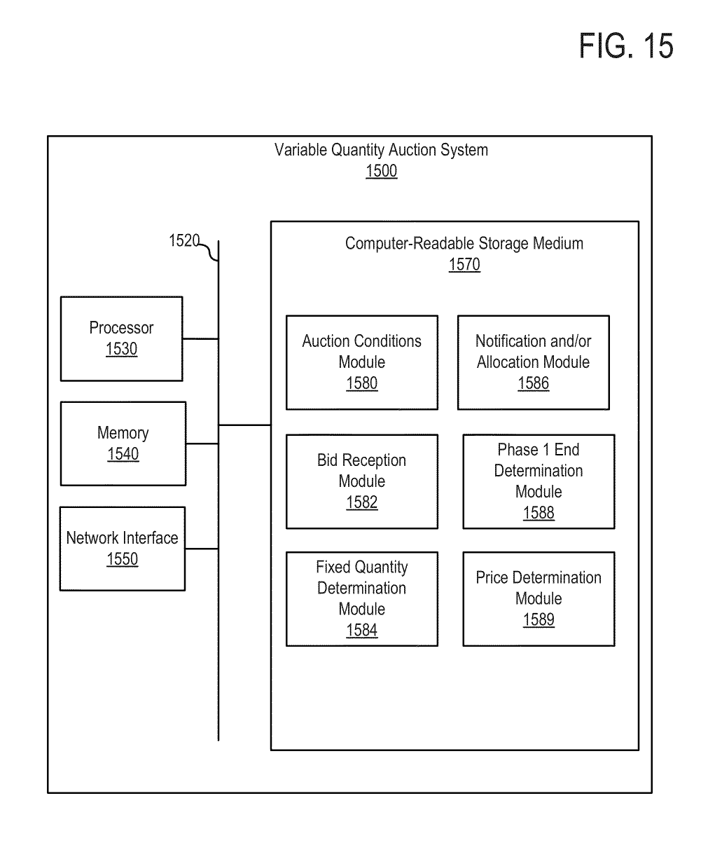

FIG. 15 illustrates a variable quantity auction system 1500 that includes a processor 1530, memory 1540, and a communication interface 1550 (illustrated as a network interface). A bus 1520 may connect the processor 1530 and/or the memory 1540 to a computer-readable storage medium 1570. The computer-readable storage medium 1570 may be non-transitory and include any number of modules for performing auction operations and methods described herein. In some embodiments, one or more of the modules 1580-1589 may be implemented in hardware and/or firmware instead of software. In other embodiments, one or more of the modules 1580-1589 may be implemented in a cloud-based or remote location and interface via a communication interface, such as network interface 1550.

As illustrated, the system may include an auction conditions module 1580 configured to receive and/or implement various auction conditions, such as a start time, end time, first phase start time, first phase end time, second phase start time, second phase end time, maximum number of auctioned items during the first phase, minimum number of auctioned items during the first phase, reserve prices, staged reserve prices based on current bid price and/or bid quantities, conditions for ending the first phase, and/or other auction conditions.

The system 1500 may include a bid reception module 1582 configured to receive bids during the first and second phases of a variable quantity auction. The bid reception module 1582 may receive bids that include a quantity of items and price per item. A fixed quantity determination module 1584 may determine the quantity of items to be auctioned during the second phase of the variable quantity auction based on the number of items for which bids were received during the first phase.

A notification and/or allocation module 1586 may notify bidders from the first phase and/or other prospective and/or registered bidders that the first phase has ended and the determined fixed quantity of items to be auctioned during the second phase of the variable quantity auction. The notification and/or allocation module 1586 may also notify winning (and possible losing) bidders at the conclusion of the auction. The notification and/or allocation module 1586 may also be configured to allocate the items when the auction is concluded.

A first phase end determination module 1588 may determine when the first phase should end. The first phase end determination module 1588 may implement any of the various methods described herein for determining when the first phase should end. A price determination module 1589 may determine the price of each item at the conclusion of the auction based on the minimum price at which the fixed quantity of items determined at the conclusion of the first phase will be sold.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims.

What is claimed is:

1. A method for conducting a variable quantity auction comprising:
establishing a quantity range of items to be auctioned via a variable quantity auction, wherein the quantity range of items includes at least a maximum quantity of items;
establishing a beginning and an end for the variable quantity auction;
establishing a reserve value corresponding to a minimum value for which bids may be placed during at least a first phase of the variable quantity auction;
receiving at least one bid from each of at least two bidders during the first phase of the variable quantity auction, wherein each bid identifies a bid quantity of items and a bid value for each item equal to at least the reserve value; and
calculating a fixed quantity of items to be auctioned during a second phase of the variable quantity auction, wherein the fixed quantity is based on a sum of the bid quantities of the at least two bidders during the first phase of the variable quantity auction, and wherein the fixed quantity is no more than the maximum quantity of items.

2. The method of claim 1, further comprising:
receiving at least one bid from a disruptive bidder during the second phase of the variable quantity auction that alters at least one of (1) a lowest bid value at which all of the fixed quantity of items would be sold, and (2) the quantity of items that would be distributed to each of the at least two bidders.

3. The method of claim 2, further comprising:
identifying a maximum closing value per item at which all of the fixed quantity of items would be sold to the at least two bidders based on the bid quantities and bid values of each of the bids of the at least two bidders.

4. The method of claim 3, further comprising:
allocating items to each of the at least two bidders at an end of the second phase of the variable quantity auction based on their respective bid quantities in order of highest bid value until the fixed quantity of items has been exhausted; and
receiving the maximum closing value in exchange for each allocated item from the at least two bidders.

5. The method of claim 3, wherein the disruptive bidder is one of the at least two bidders who bid during the first phase of the variable quantity auction.

6. The method of claim 2, wherein the disruptive bidder is not one of the at least two bidders who bid during the first phase of the variable quantity auction.

7. The method of claim 1, wherein the quantity range of items includes a minimum quantity of items to be auctioned during the variable quantity auction, and wherein the auction fails if the sum of the bid quantities of the at least two bidders during the first phase of the variable quantity auction is less than the minimum quantity of items.

8. The method of claim 1, wherein the quantity range of items includes a minimum quantity of items to be auctioned during the variable quantity auction, and further comprising:
setting the fixed quantity of items to be auctioned during the second phase of the variable quantity auction equal to the minimum quantity of items when the sum of the bid quantities of the at least two bidders during the first phase of the variable quantity auction is less than the minimum quantity of items.

9. The method of claim 1, wherein the beginning of the variable quantity auction and the end of the variable quantity auction are each defined by one of an absolute time and a triggering event.

10. The method of claim 1, wherein establishing a quantity range of items comprises receiving information identifying the quantity range from an entity other than an auctioneer of the variable quantity auction,
wherein establishing a beginning and an end of the variable quantity auction comprises receiving information identifying the beginning and the end from an entity other than the auctioneer, and
wherein establishing a reserve value comprises receiving information identifying the reserve value from an entity other than the auctioneer.

11. An electronic system for conducting a variable quantity auction comprising a processor in communication with a plurality of modules, including:
an auction condition module configured to:
receive a quantity of range of items to be auctioned via a variable quantity auction, wherein the quantity range of items includes at least a maximum quantity of items;
receive a beginning and an end for the variable quantity auction; and
receive a reserve value corresponding to a minimum value for which bids may be placed during at least a first phase of the variable quantity auction;
a bid reception module configured to receive at least one bid from each of at least two bidders during the first phase of the variable quantity auction, wherein each bid identifies a bid quantity of items and a bid value for each item equal to at least the reserve value; and
a fixed quantity determination module configured to calculate a fixed quantity of items to be auctioned during a second phase of the variable quantity auction, wherein the fixed quantity is based on a sum of the bid quantities of the at least two bidders during the first phase of the variable quantity auction, and wherein the fixed quantity is no more than the maximum quantity of items.

12. The system of claim 11, wherein one or more of the auction condition module, the bid reception module, and the fixed quantity determination module are implemented, at least partially, via hardware.

13. The system of claim 11, wherein the bid reception module is further configured to receive at least one bid from a disruptive bidder during the second phase of the variable quantity auction that alters at least one of (1) a lowest bid value at which all of the fixed quantity of items would be sold, and (2) the quantity of items that would be distributed to each of the at least two bidders.

14. The system of claim 13, wherein the disruptive bidder is one of the at least two bidders who bid during the first phase of the variable quantity auction.

15. The system of claim 13, wherein the disruptive bidder is not one of the at least two bidders who bid during the first phase of the variable quantity auction.

16. The system of claim 11, further comprising a price determination module configured to determine a maximum closing value per item at which all of the fixed quantity of items would be sold to the at least two bidders based on the bid quantities and bid values of each of the bids of the at least two bidders.

17. The system of claim 16, further comprising an allocation module configured to:
allocate items to each of the at least two bidders based on their respective bid quantities in order of highest bid value until the fixed quantity of items has been exhausted; and
receive the maximum closing value in exchange for each allocated item from the at least two bidders.

18. The system of claim 11, wherein the quantity range of items includes a minimum quantity of items to be auctioned during the variable quantity auction, and wherein the auction fails if the sum of the bid quantities of the at least two bidders during the first phase of the variable quantity auction is less than the minimum quantity of items.

19. The system of claim 11, wherein the quantity range of items includes a minimum quantity of items to be auctioned during the variable quantity auction, and
wherein the fixed quantity determination module is configured to set the fixed quantity of items to be auctioned during the second phase of the variable quantity auction equal to the minimum quantity of items when the sum of the bid quantities of the at least two bidders during the first phase of the variable quantity auction is less than the minimum quantity of items.

20. The system of claim 11, wherein the beginning of the variable quantity auction and the end of the variable quantity auction are each defined by one of an absolute time and a triggering event.

21. The system of claim 11, wherein establishing a quantity range of items comprises receiving information identifying the quantity range from an entity other than an auctioneer of the variable quantity auction,
wherein establishing a beginning and an end of the variable quantity auction comprises receiving information identifying the beginning and the end from an entity other than the auctioneer, and
wherein establishing a reserve value comprises receiving information identifying the reserve value from an entity other than the auctioneer.

22. A method for conducting a variable quantity auction comprising:
receiving information related to a quantity range of items to be auctioned via a variable quantity auction, wherein the quantity range of items includes at least a maximum quantity of items;
receiving information related to a beginning and an end for the variable quantity auction;
receiving information related to a reserve value corresponding to a minimum value for which bids may be placed during at least a first phase of the variable quantity auction;
receiving information related to at least one bid from each of at least two bidders during the first phase of the variable quantity auction, wherein each bid identifies a bid quantity of items and a bid value for each item equal to at least the reserve value;
determining a fixed quantity of items to be auctioned during a second phase of the variable quantity auction, wherein the fixed quantity is based on a sum of the bid quantities of the at least two bidders during the first phase of the variable quantity auction, and wherein the fixed quantity is no more than the maximum quantity of items;
receiving at least one bid during the second phase of the variable quantity auction that alters at least one of (1) a lowest bid value at which all of the fixed quantity of items would be sold, and (2) the quantity of items that would be distributed to each of the at least two bidders;
identifying a maximum closing value per item at which all of the fixed quantity of items would be sold to the at least two bidders based on the bid quantities and bid values of each of the bids of the at least two bidders;
allocating items to each of the at least two bidders at an end of the second phase of the variable quantity auction based on their respective bid quantities in order of highest bid value until the fixed quantity of items has been exhausted; and
receiving the maximum closing value in exchange for each allocated item from the at least two bidders.
